(19) United States
(12) Patent Application Publication
(10) Pub. No.: US 2003/0130870 A1
(43) Pub. Date: Jul. 10, 2003

(54) Automated medical consultation appointment system

(75) Inventor: Kouichi Tsuchimura, Kawasaki-shi (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/132,305

(22) Filed: Apr. 26, 2002

(30) Foreign Application Priority Data
Jan. 7, 2002 (JP) 2002-000467

(51) Int. Cl. G06F 17/60

(52) U.S. Cl. 705/2

(57) ABSTRACT

A consultation appointment system utilizes a main computer connected to a system subscriber via networks for providing the system subscriber with an automated consultation appointment service. The main computer incorporates an information receiver, an institution selector, a consultation appointment manager and a consultation appointment manager. The information receiver receives personal data and test data of the system subscriber. The institution selector selects a medical institution suitable for the system subscriber based on the subscriber's personal data and test data. The consultation appointment manager makes a consultation appointment with the selected medical institution. The appointment result informer notifies the terminal of the system subscriber about the result of the consultation appointment made with the selected medical institution.

### BACKGROUND OF THE INVENTION

1. Field of the Invention

The present invention relates to an automated medical consultation appointment system utilizing a main computer that is connected to a system subscriber's terminal and a medical institution's terminal via a network. The present invention also relates to a consultation appointment method, a computer and a computer program.

2. Description of the Related Art

When people visit a clinic or hospital for treatment of their sickness, it is desirable for them to be consulted immediately. However, sometimes they have to wait for a long time (in an extreme case, two or three hours) until their turns come round, since a lot of people may have been waiting earlier. For all that, a patient should feel luckier if the doctor is the right person to cure his or her illness. It can happen that the patient's condition is found to be more serious than expected, and the doctor's facilities are inappropriate for proper treatment. In such a case, the poor patient should make arrangements to go to another hospital which is better-equipped. Clearly, the long waiting and unexpected change of hospitals are not good for a quick recovery from the illness.

Another problem is as follows. People generally do not visit a clinic or hospital until their illness progresses to such an extent that they are conscious of a physical disorder. For facilitating quick remedy, however, it is desirable to see a doctor before the illness has thus progressed. To this end, a regular checkup such as a blood test may be beneficial to grasping the physical condition. One convenient way to take a blood test is blood donation. When people donate blood (at a blood-donor center for example), they will have the benefit of a free blood examination regarding blood component concentration, cholesterol level, blood sugar level, etc., that is conducted by the blood-gathering institution. Thus, people can check their own physical condition by donating blood regularly. In this case, however, it is the blood donor himself who has to decide whether or not to see a doctor, which hospital to visit, and so on. In most cases, the blood donor is a layman about health care, thereby resulting in making wrong judgments about the progress of the disease or selection of the medical institution.

### SUMMARY OF THE INVENTION

The present invention has been proposed under the circumstances described above. It is, therefore, an object of the present invention to provide an automated consultation appointment system whereby a system subscriber can take an immediate medical consultation in the right medical institution before his disorder progresses.

According to a first aspect of the present invention, there is provided a consultation appointment system that includes: a main computer connected to a first terminal of a system subscriber via a network; an information receiver that receives personal data and test data of the system subscriber; an institution selector that selects a medical institution suitable for the system subscriber based on the subscriber's personal data and test data; a consultation appointment manager that makes a consultation appointment with a second terminal of the medical institution; and an appointment result informer that notifies the first terminal about the result of the consultation appointment made with the second terminal. The above-mentioned information receiver, institution selector, consultation appointment manager and appointment result informer are incorporated in the main computer.

Preferably, the information receiver may receive the subscriber's personal data from the first terminal, while also receiving the subscriber's test data form a third terminal of a testing institution that conducts testing based on a sample collected from the system subscriber.

According to a second aspect of the present invention, there is provide a consultation appointment method for providing a system subscriber with a consultation appointment service by utilizing a main computer connected to a first terminal of the system subscriber via a network. The method includes the steps of: receiving personal data and test data of the system subscriber; selecting a medical institution suitable for the system subscriber based on the subscriber's personal data and test data; making a consultation appointment with a second terminal of the medical institution; and informing the first terminal about the result of the consultation appointment made with the second terminal. All the above-mentioned steps are performed by the main computer.

Preferably, the subscriber's personal data may be supplied from the first terminal, while the subscriber's test data supplied from a third terminal of a testing institution that conducts testing based on a sample collected from the system subscriber.

Preferably, the medical institution suitable for the system subscriber may be closer to the residence of the system subscriber than any other medical institution capable of performing medical treatment on the system subscriber.

Preferably, the method of the present invention may further include the steps of sending the subscriber's personal data from the first terminal to the main computer, and causing the first terminal to receive a consultation appointment result from the main computer.

According to a third aspect of the present invention there is provided a computer connected to a first terminal of a system subscriber via a network for providing the system subscriber with a consultation appointment service. The computer includes: an formation receiver that receives personal data and test data of the system subscriber; an institution selector that selects a medical institution suitable for the system subscriber based on the subscriber's personal data and test data; a consultation appointment manager that makes a consultation appointment with a second terminal of the medical institution; and an appointment result informer that notifies the first terminal about the result of the consultation appointment.

Preferably, the information receiver may receive the subscriber's personal data from the first terminal, while also receiving the subscriber's test data from a third terminal of a testing institution that conducts testing based on a sample collected from the system subscriber.

According to a fourth aspect of the present invention, there is provided a terminal used for a consultation appointment system including a main computer that is connected to a medical institution via a network. The main computer incorporates an information receiver for receiving system subscriber-specific data, an institution selector for selecting a, medical institution based the system subscriber-specific data, a consultation appointment manager for making a consultation appointment with the medical institution, and an appointment result informer for notifying the system subscriber about the result of the consultation appointment. The terminal includes: an information supplier that sends the system subscriber-specific data to the main computer; and an appointment result receiver that receives a consultation appointment result supplied from the main computer.

According to a fifth aspect of the present invention, there is provided a computer program for providing a system subscriber with a consultation appointment service using a main computer connected to the system subscriber. The program is designed to execute the steps of: receiving personal data and test data of the system subscriber; selecting a medical institution suitable for the system subscriber based on the subscriber's personal data and test data; making a consultation appointment with the medical institution; and notifying the system subscriber about the result of the consultation appointment made with the medical institution.

Other features and advantages of the present invention will become apparent from the detailed description given below with reference to the accompanying drawings.

### BRIEF DESCRIPTION OF THE DRAWINGS

FIG. 1 illustrates the basic structure of the consultation appointment system according to the present invention;

FIG. 2 illustrates the operational flow of the appointment system of FIG. 1; and

FIG. 3 is a flow chart illustrating the institution selecting procedure of the above system.

### DETAILED DESCRIPTION OF THE PREFERRED EMBODIMENT

The preferred embodiments of the present invention will be described below with reference to the accompanying drawings.

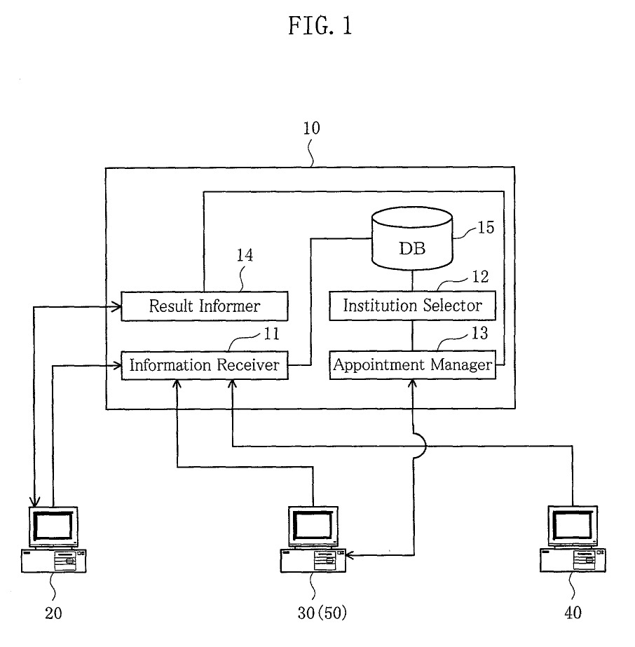

FIG. 1 illustrates a medical consultation appointment system according to the present invention. The appointment system utilizes a communications network to link a user (system subscriber) to a medical institution. In accordance with this system, the user is supposed to have a medical checkup (blood test/urine analysis/etc.) at regular intervals. Based on the checkup results, a hospital or clinic that the user should visit is automatically selected, and a consultation appointment with the doctor of the selected hospital is made, which is also automatic.

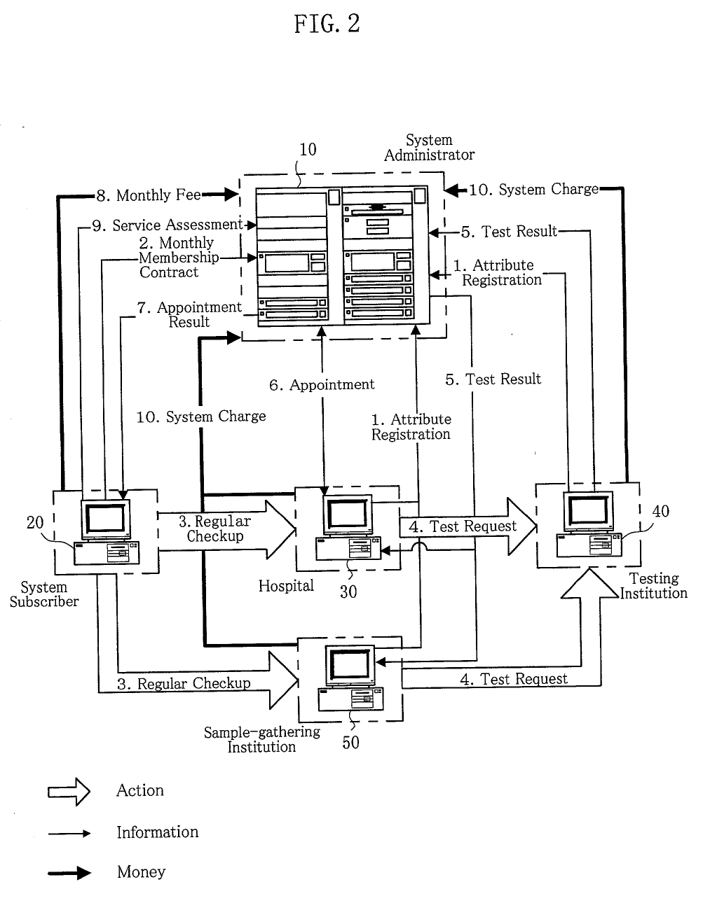

As seen from FIGS. 1 and 2, the appointment system of the present invention includes a main computer 10 and a plurality of terminals (only first to fourth terminals 20, 30, 40, 50 are shown in the illustrated example) These terminals can access the main computer 10 via an appropriate network (the Internet for example). The terminals are typically personal computers equipped with communications functions. As an example, the first terminal 20 may be installed at the home of a system subscriber, the second terminal 30 in a hospital (or clinic), the third terminal 40 in a sample testing institution, and the fourth terminal 50 in a blood/urine-gathering institution.

The main computer 10 incorporates a central processing unit (CPU), an internal memory (hard magnetic disks), various input/output devices, etc. The main computer 10 is managed by a system administrator of the appointment system. The main computer 10 itself may function as a World Wide Web (WWW) server. Alternatively, the main computer 10 may be connectable to a WWW server via the network. The CPU of the computer 10, operating in accordance with prescribed programs, serves as an information receiver 11, an institution selector 12, an appointment manager 13 and an appointment result informer 14. The CPU-working programs, together with other programs and data, are stored in the hard disks of the internal memory. The hard disks also store database 15.

The information receiver 11 fulfils the following functions. First, the receiver 11 registers the personal data of the system subscriber. Specifically, the receiver 11 receives the subscriber's attribute data including the patient's name, age, gender, address, telephone number, email address, etc. The personal attribute data is supplied from the terminal 20 through a Web page for example. The receiver 11 adds the received data to the database 15. Secondly, the receiver 11 registers institution-specific attribute data supplied from a hospital (through a Web page) by the terminal 30, or supplied from a sample-gathering institution by the terminal 50. The attribute data from the hospital and the sample-gathering agency may each contain the institution's name, address, telephone number, email address, etc. In addition to these items, the hospital-specific attribute data may contain information about what departments (i.e., internal medicine, surgery, pediatrics, etc.) the hospital has. All the received data is added to the database 15. Thirdly, the information receiver 11 registers institution-specific attribute data supplied from a sample-testing institution (through a Web page) by the terminal 40. The attribute data from the sample-testing institution may contain the institution's name, address, telephone number, email address, etc. In addition to these items, the data may contain information about what kinds of testing (i.e., blood-testing, urinalysis, etc.) the institution can do. All the received data is added to the database 15. Fourthly, the information receiver 11 registers the results of a patient-specific testing conducted by the sample-testing institution. The result data is supplied from the testing institution (through a Web page) by the terminal 40, to be added to the database 15. The registered data may contain the personal attribute data (name, address, etc.) of the subscriber and the classified results of the conducted tests.

The institution selector 12 refers to the hospital-specific information registered in the database 15 and selects an appropriate hospital or clinic for the subscriber. This selection is made in accordance with the patient's attribute data and the test results registered in the database 15. Specifically, the institution selector 12 refers to the registered test results of the subscriber to determine whether any positive test result is contained in the registered test data. When there is a positive test result, this means that the result value is outside a normal range that represents healthy people, and therefore the subscriber should visit a specialist for a workup and/or treatment. In this case, the institution selector 12 searches the database 15 for a hospital (or hospitals) with appropriate facilities for treating the subscriber. Preferably, the selected hospital is near the patient's residence. The selection result is supplied to the appointment manager 13 from the selector 12.

Upon receiving the selection data, the appointment manager 13 accesses the terminal 30 of the selected hospital to communicate information necessary for making a consultation appointment. In the terminal 30, consultation schedule data is stored and managed. The appointment manager 13 requires the terminal 30 of the hospital to incorporate an appointment of the subscriber into the consultation schedule. When the desired appointment is properly made, the appointment result (the appointed date, time, etc.) is supplied to the result informer 14 from the appointment manager 13.

The result informer 14 sends the supplied appointment result to the terminal 20 of the subscriber by email. Then, the subscriber can know the appointment date, time, etc. by opening the appropriate file, sent from the result informer 14.

According to the present invention, as described above, a system user does not worry about which hospital or clinic to visit, nor take the trouble to make a consultation appointment by himself. Instead, he only needs to have his blood, urine, etc. checked regularly.

The operational flow of the appointment system will now be described below with reference to FIG. 2.

[1. Attribute Registration]

As noted above, the main computer 10 registers the attribute information of the hospital (terminal 30), the sample-testing institution (terminal 40) and the sample-gathering institution (terminal 50).

[2. Monthly Membership Contract]

The main computer 10 registers a monthly membership contract effected with a system subscriber through his terminal 20.

[3. Regular Checkup]

The system subscriber visits a hospital or sample-gathering institution to have his blood, urine, etc., sampled.

[4. Test Request]

The sample-gathering institution or the hospital gathers blood, urine, etc., from the subscriber. The collected samples are sent to the sample-testing institution for analysis.

[5. Test Result Notification]

The results of the analysis are supplied to the main computer 10 from the terminal 40 of the testing institution. The analysis results are then sent to the terminal 30 of the hospital and the terminal 50 of the sample-gathering institution.

[6. Consultation Appointment]

Upon receiving the analysis results from the testing institution, the main computer 10 determines whether a positive test result is contained in the received data. When such a result is found, the main computer 10 selects an appropriate hospital, among the registered hospitals, that can treat the disease of the subscriber. When there are two or more capable candidates, the main computer 10 may select one of them that is the closest to the residence of the subscriber. Then, the main computer 10 automatically makes a consultation appointment with a doctor of the selected hospital by data communication with the terminal 30.

According to the present invention, the final selection may provide two or more hospitals as candidates for treatment of the subscriber. In this case, provisional appointments may be made with the respective hospitals in accordance with the order of priority, and thereafter the subscriber may select the most convenient one among the provisional appointments.

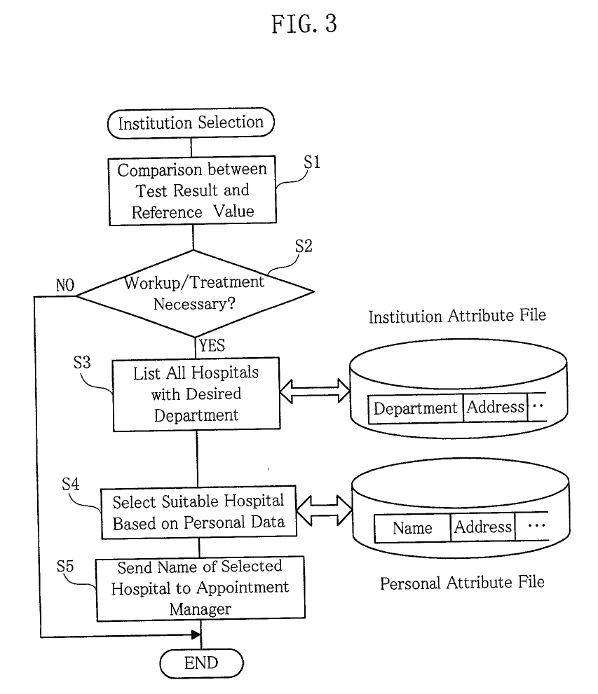

Referring now to FIG. 3, the institution selector 12 operates as follows.

The institution selector 12 receives the test results of the subscriber supplied from the testing institution. Then, the selector 12 compares the obtained result with a prescribed reference value (S1).

When workup and/or medical treatment is found necessary (S2:YES) as a result of the above comparison, the selector 12 refers to the institution attribute files of the database 15 to list all the hospitals or clinics with the department or facilities that can perform appropriate treatment or workup for the subscriber (S3). When no workup nor treatment is necessary (S2:NO), the ‘institution selection’ procedure comes to an end.

After the listing (S3), the selector 12 accesses the database 15 again to refer to the personal attribute files of the subscriber. Then, the selector 12 select one of the hospitals that is the closest to the residence of the subscriber (S4).

The selector 12 then informs the appointment manager 13 of the name of the selected hospital (S5), so that the manager 13 will make an appointment with the hospital. Thus, the institution selection procedure is over.

[7. Appointment Result Notification]

The result of the automated consultation appointment is sent by email from the main computer 10 to the terminal 20 of the subscriber. Thereafter, the subscriber confirms the appointment results (the hospital name, the consultation date and time, etc.). According to the present invention, the test results of the sample analysis by the testing institution may be emailed to the terminal 20 of the subscriber before or together with the notification of the consultation appointment. When no consultation appointment is made, only the test results may be sent to the terminal 20.

[8. Monthly Fee Payment]

The main computer 10 emails a bill to the terminal 20 for payment of the monthly membership fee. Then, the system subscriber pays the bill to the system administrator in charge of the main computer 10.

[9. Service Assessment Registration]

After receiving the automated appointment service, the system subscriber assesses the service by filling out a questionnaire emailed to the terminal 20 from the main computer 10. The questionnaire may includes questions such as ‘Was the treatment you received appropriate?’, ‘Was the sample analysis by the testing institution accurate?’, and so on. The assessments by the system subscriber, which are registered in the main computer 10, are considered for the subsequent selection of a hospital.

[10. System Charge Payment]

The main computer 10 sends a bill for payment of the system charge to the terminals 30, 40 and 50 by email for example. In accordance with the prescribed charges, the hospital (terminal 30), the testing institution (terminal 40) and the sample-gathering institution (terminal 50) pay the required amount to the system administrator in charge of the main computer 10.

In accordance with the automated appointment system of the present invention, the system subscriber can immediately seek a consultation with a doctor in the hospital of the right choice, without worrying about which hospital to visit nor taking trouble to make an appointment by himself.

The appointment system of the present invention is also advantageous on the side of a hospital since the appointment with the outpatient (system subscriber) is automatically made. Further, a sample-gathering institution (in particular, a blood-donor center) benefits from the appointment system since an increase in the amount of donating blood is expected as the number of system subscribers increases.

In the above-described embodiment, the hospital, the sample-gathering institution and the testing institution are described as separate, though the present invention is not limited to this. For instance, a single institution may be provided with all the facilities necessary to serve as a hospital, a sample-gathering institution and a testing institution.

In the above-described embodiment, data communication is performed via the Internet, using a Web page and email. Alternatively, the terminal 20 of the system subscriber may be replaced by a portable telephone or conventional non-portable telephone (including a facsimile machine). The data communication between the main computer 10 and such a telephone may be performed by analog (audio) signals or digital signals.

The above-described appointment system is an open system to which anyone can have access via the Internet. Alternatively, the appointment system may be so designed as to prevent unqualified persons from accessing the main computer 10. An ‘unqualified’ person may be a person who does not have communications software for allowing access to the main computer 10.

The appointment system of the present invention may not need to adopt the membership system as described above. For instance, the appointment system may be utilizable by anyone that has registered required personal data in the main computer 10.

In the above-described embodiment, the consultation appointment is made automatically based on the data communication between the main computer 10 and the terminal 30 of the hospital. Alternatively, the preference of the system subscriber may be reflected in the consultation appointment. Specifically, a consultation appointment form including a dialogbox may be displayed on the monitor of the terminal 20. The system subscriber enters his convenient date and time for the consultation appointment by the terminal 20. The main computer 10 considers both the current appointment schedule of the selected hospital and the subscriber's preference to produce the most suitable plan for the subscriber and the hospital. An appointment may be made with the sample-gathering institution, as well as the hospital.

The main computer 10 may be managed by a medical fraternity or any other organization to which the hospital is related.

The main computer 10 may refer to the history of the subscriber's test results in deciding whether a consultation appointment should be made. In this case, the computer 10 may make a consultation appointment when a relatively abnormal sign is found in the current test result.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A consultation appointment system comprising:
a main computer connected to a first terminal of a system subscriber via a network;
an information receiver that receives personal data and test data of the system subscriber;
an institution selector that selects a medical institution suitable for the system subscriber based on said personal data and said test data;
a consultation appointment manager that makes a consultation appointment with a second terminal of the medical institution; and
an appointment result informer that notifies the first terminal about a result of the consultation appointment made with the second terminal;
wherein the information receiver, the institution selector, the consultation appointment manager and the appointment result informer are incorporated in the main computer.

2. The system according to claim 1, wherein the information receiver receives said personal data from the first terminal, while also receiving said test data form a third terminal of a testing institution that conducts testing based on a sample collected from the system subscriber.

3. A consultation appointment method for providing a system subscriber with a consultation appointment service by utilizing a main computer connected to a first terminal of the system subscriber via a network, the method comprising the steps of:
receiving personal data and test data of the system subscriber;
selecting a medical institution suitable for the system subscriber based on said personal data and said test data;
making a consultation appointment with a second terminal of the medical institution; and
informing the first terminal about a result of the consultation appointment made with the second terminal;
wherein the steps are performed by the main computer.

4. The method according to claim 3, wherein said personal data is supplied from the first terminal, said test data being supplied from a third terminal of a testing institution that conducts testing based on a sample collected from the system subscriber.

5. The method according to claim 3, wherein the medical institution suitable for the system subscriber is closer to a residence of the system subscriber than any other medical institution capable of performing medical treatment on the system subscriber.

6. The method according to claim 3, further comprising the steps of sending said personal data from the first terminal to the main computer, and causing the first terminal to receive a consultation appointment result from the main computer.

7. A computer connected to a first terminal of a system subscriber via a network for providing the system subscriber with a consultation appointment service, the computer comprising:
an formation receiver that receives personal data and test data of the system subscriber;
an institution selector that selects a medical institution suitable for the system subscriber based on said personal data and said test data;
a consultation appointment manager that makes a consultation appointment with a second terminal of the medical institution; and
an appointment result informer that notifies the first terminal about a result of the consultation appointment.

8. The computer according to claim 7, wherein the information receiver receives said personal data from the first terminal, while also receiving said test data from a third terminal of a testing institution that conducts testing based on a sample collected from the system subscriber.

9. A terminal used for a consultation appointment system including a main computer that is connected to a medical institution via a network and incorporates an information receiver for receiving system subscriber-specific data, an institution selector for selecting a medical institution based the system subscriber-specific data, a consultation appointment manager for making a consultation appointment with the medical institution, and an appointment result informer for notifying the system subscriber about a result of the consultation appointment, the terminal comprising:
an information supplier that sends said system subscriber-specific data to the main computer; and
an appointment result receiver that receives a consultation appointment result supplied from the main computer.

10. A computer program for providing a system subscriber with a consultation appointment service using a main computer connected to the system subscriber, the program designed to execute the steps of:
receiving personal data and test data of the system subscriber;
selecting a medical institution suitable for the system subscriber based on said personal data and said test data;
making a consultation appointment with the medical institution; and
notifying the system subscriber about a result of the consultation appointment made with the medical institution.
